(19) United States
(12) Patent Application Publication
(10) Pub. No.: US 2017/0084910 A1
(43) Pub. Date: Mar. 23, 2017

(54) NEGATIVE ELECTRODE PLATE FOR NONAQUEOUS ELECTROLYTE SECONDARY BATTERY AND NONAQUEOUS ELECTROLYTE SECONDARY BATTERY

(71) Applicant: SANYO Electric Co., Ltd., Daito-shi, Osaka (JP)

(72) Inventors: Tomohiro Ichikawa, Tokushima (JP); Yasunobu Iwami, Tokushima (JP); Katsuya Imai, Tokushima (JP)

(73) Assignee: SANYO Electric Co., Ltd., Daito-shi, Osaka (JP)

(21) Appl. No.: 15/126,532

(22) PCT Filed: Mar. 18, 2015
(86) PCT No.: PCT/JP2015/001508

§ 371 Date: Sep. 15, 2016

(30) Foreign Application Priority Data
Mar. 25, 2014 (JP) 2014-061354

(51) Int. Cl. H01M 4/36; H01M 4/48; H01M 10/0525; H01M 4/66; H01M 4/62

(52) U.S. Cl. CPC H01M 4/364; H01M 4/661; H01M 4/622; H01M 10/0525; H01M 4/483; H01M 4/625; H01M 2004/027

(57) ABSTRACT

A negative electrode plate for nonaqueous electrolyte secondary batteries according to an embodiment of the present invention includes a negative electrode mix layer, placed on a negative electrode core, containing a negative electrode active material capable of storing and releasing lithium ions. The negative electrode core is copper foil having a thickness of 5.9 μm to 8.1 μm and a surface roughness Rz of 0.8 μm to 1.5 μm. The negative electrode mix layer contains the negative electrode active material, a binding agent, and a carboxymethylcellulose-ammonium salt. The negative electrode active material is composed of a mixture of a graphite material and a silicon oxide represented by SiOₓ (0.5≦x<1.6). The content of the silicon oxide in the negative electrode active material is 0.5% to 20% by mass.

### TECHNICAL FIELD

The present invention relates to a negative electrode plate, using a mixture of a silicon oxide (SiOₓ, 0.5≦x<1.6) and a graphite material as a negative electrode active material, for nonaqueous electrolyte secondary batteries, the negative electrode plate being capable of achieving high capacity and excellent capacity retention (cycle characteristics), and also relates to a nonaqueous electrolyte secondary battery including the negative electrode plate.

### BACKGROUND ART

Carbonaceous materials such as graphite and amorphous carbon are widely used as negative electrode active materials for use in nonaqueous electrolyte secondary batteries. However, in the case of using a negative electrode active material made of a carbon material, lithium can only be intercalated up to a composition of LiC₆ and the theoretical capacity is up to 372 mAh/h. This is an obstacle to obtaining high-capacity batteries. Therefore, the following batteries are under development: nonaqueous electrolyte secondary batteries using silicon, which alloys with lithium, a silicon alloy, or a silicon oxide as a negative electrode active material with a high energy density per mass and volume. In this case, for example, lithium can be intercalated up to a composition of Li_{4.4}Si and therefore the theoretical capacity is 4,200 mAh/g; hence, a larger capacity can be expected rather than the case of using a carbon material as a negative electrode active material.

For example, Patent Literature 1 discloses a nonaqueous electrolyte secondary battery using one containing a material (in which the element ratio x of oxygen to silicon satisfies 0.5≦x≦1.5 and which is hereinafter referred to as the “silicon oxide”) containing silicon and oxygen as constituent elements and graphite as a negative electrode active material. In the nonaqueous electrolyte secondary battery, a negative electrode active material in which the percentage of the silicon oxide is 3% to 20% by mass on the basis that the total of the silicon oxide and graphite is 100% by mass is used.

According to the nonaqueous electrolyte secondary battery disclosed in Patent Literature 1, the silicon oxide, which has high capacity and exhibits a large change in volume due to charge or discharge, is used and reductions in battery properties due to the change in volume thereof can be suppressed. Therefore, good battery properties can be ensured without significantly changing the configuration of a conventional nonaqueous electrolyte secondary battery.

On the other hand, in the case of using a negative electrode active material significantly expanding and contracting due to charge and discharge like the above-mentioned silicon oxide, in order to ensure the adhesion between copper foil serving as a negative electrode core and a negative electrode mix layer containing the negative electrode active material, the copper foil needs to have a certain surface roughness. Therefore, for example, Patent Literature 2 discloses the invention of a negative electrode for lithium secondary batteries. The negative electrode includes a negative electrode plate including a negative electrode core with a surface roughness Rz of 5.0 μm or more and a dense film, composed of a SiOₓ vacuum-deposited film, placed on a surface of the negative electrode core. Furthermore, Patent Literature 3 discloses an example of using carbonaceous matter as a negative electrode active material. In the example, electrolytic copper foil having a thickness of 9.5 μm to 12.5 μm and a surface roughness Rz of 1.0 μm to 2.0 μm is used as a negative electrode core.

### CITATION LIST

### Patent Literature

PTL 1: Japanese Published Unexamined Patent Application No. 2010-212228

PTL 2: Japanese Published Unexamined Patent Application No. 2007-053085

PTL 3: International Publication No. WO 2008/132987

PTL 4: Japanese Published Unexamined Patent Application No. 2005-100773

### SUMMARY OF INVENTION

### Technical Problem

According to the invention of the negative electrode for lithium secondary batteries disclosed in Patent Literature 2, since the surface roughness Rz of the negative electrode core is large, the capacity per volume is increased rather than conventional examples and the initial efficiency and the capacity retention are enhanced in association with the fact that a negative electrode active material is composed of the SiOₓ vacuum-deposited film. However, the negative electrode for lithium secondary batteries disclosed in Patent Literature 2 contains the negative electrode active material composed of the silicon oxide vacuum-deposited film and therefore cannot provide such a predetermined action effect as disclosed in Patent Literature 2 in the case of application to a negative electrode active material composed of a mixture of a silicon oxide and graphite.

According to the invention of the copper foil for lithium secondary batteries disclosed in Patent Literature 3, the yield strength and elongation of the copper foil, which is used as the negative electrode core, are large and therefore the negative electrode core is unlikely to be broken even if the expansion and contraction of the negative electrode active material during charge and discharge are large; hence, good capacity retention is obtained. However, a lithium secondary battery disclosed in Patent Literature 3 is applied to the case of using carbonaceous matter as the negative electrode active material. In the case of application to a lithium secondary battery containing a negative electrode active material containing a component, such as a silicon oxide, expanding and contracting significantly, the capacity retention is insufficient.

When the surface roughness Rz of copper foil used as a negative electrode is within a predetermined range, the contact area of a negative electrode is large. Therefore, it is clear that good capacity retention is obtained. However, from the viewpoint of increasing the capacity of a nonaqueous electrolyte secondary battery, the thickness of copper foil used as a negative electrode core is required to be reduced. This shows that the thickness of copper foil used as a negative electrode core is required to be reduced for the purpose of achieving the increase in capacity of a nonaqueous electrolyte secondary battery and the surface roughness Rz of the copper foil needs to be small for the purpose of increasing the strength of a negative electrode core.

However, the reduction in thickness of a negative electrode core and the increase in surface roughness thereof lead to the reduction in strength of copper foil used as the negative electrode core. Therefore, in the case of using a negative electrode active material, such as a silicon oxide, expanding and contracting significantly, it is difficult to use a negative electrode core with a small thickness.

For example, a nonaqueous electrolyte secondary battery including a negative electrode core made of copper foil having a thickness of 8 μm or less and a surface roughness Rz of 2.0 μm or more is often broken during compression for forming a negative electrode mix layer. The reason for this is that increasing the surface roughness Rz of the copper foil as the negative electrode core with the thickness maintained constant increases a region occupied by an irregular portion in the thickness and reduces the thickness of a portion of the copper foil.

Furthermore, when the bonding between a silicon oxide represented by SiOₓ and copper foil as a negative electrode core is insufficient, the silicon oxide is separated from the negative electrode core by repeating a charge/discharge cycle, leading to a reduction in capacity retention. Therefore, in the case of using one containing the silicon oxide represented by SiOₓ as a negative electrode active material, the following battery is demanded: a nonaqueous electrolyte secondary battery, capable of achieving higher capacity and excellent capacity retention, including copper foil, used as a negative electrode core, having a reduced thickness.

Patent Literature 4 discloses the invention of a nonaqueous electrolyte secondary battery including a negative electrode plate containing a carboxymethylcellulose (CMC)-ammonium salt used as a binding agent in the case of using carbonaceous matter as a negative electrode active material. According to the nonaqueous electrolyte secondary battery disclosed in Patent Literature 4, the CMC-ammonium salt, which is used as a portion of the binding agent, can stably cover the surfaces of negative electrode active material particles and abnormal heat generation due to overcharge is suppressed. However, Patent Literature 4 neither describes the use of the CMC-ammonium salt as a binding agent or a thickener when a silicon oxide is contained as a negative electrode active material nor suggests an action effect in that case.

### Solution to Problem

In accordance with a negative electrode plate for nonaqueous electrolyte secondary batteries according to an embodiment of the present invention, a negative electrode plate for nonaqueous electrolyte secondary batteries is provided.

The negative electrode plate includes a negative electrode mix layer, placed on a negative electrode core, containing a negative electrode active material capable of storing and releasing lithium ions.

The negative electrode core is copper foil having a thickness of 5.9 μm to 8.1 μm and a surface roughness Rz of 0.8 μm to 1.5 μm.

The negative electrode mix layer contains the negative electrode active material, a binding agent, and a CMC-ammonium salt. The negative electrode active material is composed of a mixture of a graphite material and a silicon oxide represented by SiOₓ (0.5≦x<1.6).

The content of the silicon oxide in the negative electrode active material is 0.5% to 20% by mass.

In the negative electrode plate for nonaqueous electrolyte secondary batteries according to an embodiment of the present invention, the negative electrode active material contains not only the graphite material but also the silicon oxide, which is represented by SiOₓ (0.5≦x<1.6). The content of the silicon oxide in the negative electrode active material is 0.5% to 20% by mass. The silicon oxide exhibits a larger change in volume due to charge or discharge as compared to the graphite material and has a theoretical capacity larger than that of the graphite material. Therefore, in accordance with the negative electrode plate for nonaqueous electrolyte secondary batteries according the present invention, a battery capacity larger than that of a negative electrode plate, containing a negative electrode active material containing a graphite material only, for nonaqueous electrolyte secondary batteries can be achieved.

In the negative electrode plate for nonaqueous electrolyte secondary batteries according to an embodiment of the present invention, the negative electrode mix layer contains the CMC-ammonium salt. The CMC-ammonium salt can stably cover the surface of the negative electrode active material. Therefore, even though the surface roughness Rz of the copper foil, which is the negative electrode core, is small, 0.8 μm to 1.5 μm, the strong bonding between the negative electrode active material and the strong bonding between the negative electrode active material and the negative electrode core can be achieved. This suppresses the breakage of the negative electrode core when the negative electrode core is compressed for the purpose of forming the negative electrode mix layer in the manufacture of the negative electrode plate and enables the separation of the negative electrode active material to be suppressed even though the silicon oxide expands and contracts significantly during charge and discharge, thereby enabling a nonaqueous electrolyte secondary battery capable of achieving good capacity retention to be obtained.

In addition, since the thin copper foil, which has a thickness of 5.9 μm to 8.1 μm, is used as the negative electrode core, the negative electrode mix layer can account for a large proportion of the negative electrode plate. Therefore, a nonaqueous electrolyte secondary battery with high capacity is obtained. In particular, in the case of applying the negative electrode plate for nonaqueous electrolyte secondary batteries according to the embodiment to a flat wound electrode assembly, the copper foil as the negative electrode core is unlikely to be broken when a wound electrode assembly is compressed so as to be flat; hence, a nonaqueous electrolyte secondary battery exhibiting increased capacity and excellent capacity retention is obtained.

When the content of the silicon oxide in the negative electrode active material is less than 0.5% by mass, the effect of increasing the capacity by the use of the silicon oxide as the negative electrode active material is not achieved. Likewise, when the content of the silicon oxide, which is represented by SiOₓ, in the negative electrode active material is more than 20% by mass, the capacity retention is low because the negative electrode active material is pulverized by the significant expansion and contraction of the silicon oxide due to charge and discharge or a conductive network is disrupted.

When the thickness of the copper foil as the negative electrode core is less than 5.9 mm, the strength of the copper foil is low and therefore the copper foil is likely to be broken when the copper foil is compressed for the purpose of forming the negative electrode mix layer. Likewise, when the thickness of the copper foil is more than 8.1 μm, the battery capacity is low because the increase in thickness of the copper foil reduces the amount of the negative electrode active material. When the surface roughness Rz of the copper foil, which is the negative electrode core, is less than 0.8 μm, the adhesion between the negative electrode active material and the copper foil is low, leading to a reduction in capacity retention. Likewise, when the surface roughness Rz of the copper foil is more than 1.5 μm, a region occupied by an irregular portion in the thickness is large and a portion with a small thickness is partly present in the copper foil; hence, this portion is likely to be broken during compression for forming the negative electrode mix layer.

### BRIEF DESCRIPTION OF DRAWING

FIG. 1 is a perspective view of a laminate-type nonaqueous electrolyte secondary battery common to experiment examples.

### DESCRIPTION OF EMBODIMENTS

Embodiments of the present invention are described below in detail using experiment examples. The experiment examples shown below are exemplified for the purpose of embodying the technical spirit of the present invention. It is not intended to limit the present invention to the experiment examples. The present invention is applicable to various modifications made without departing from the technical spirit described in the claims.

First, the configuration of a nonaqueous electrolyte secondary battery common to the experiment examples is described in detail.

### [Preparation of Positive Electrode Plate]

A positive electrode plate was prepared as described below. During the synthesis of cobalt carbonate (CoCO₃), 0.1% by mole of zirconium, 1% by mole of magnesium, and 1% by mole of aluminium were co-precipitated with respect to cobalt and this was subjected to a thermal decomposition reaction, whereby zirconium-magnesium-aluminium-containing tricobalt tetroxide was obtained. This was mixed with lithium carbonate (Li₂CO₃) serving as a lithium source, followed by firing at 850° C. for 20 hours, whereby a zirconium-magnesium-aluminium-containing lithium-cobalt composite oxide (LiCo_{0.979}Zr_{0.001}Mg_{0.01}Al_{0.01}O₂) was obtained.

The following powders were mixed together: 95 parts by mass of a powder of the zirconium-magnesium-aluminium-containing lithium-cobalt composite oxide, which was synthesized as a positive electrode active material as described above; 2.5 parts by mass of a powder of a carbon material serving as a conductive agent; and 2.5 parts by mass of a powder of polyvinylidene fluoride (PVdF) serving as a binding agent. This was mixed with N-methylpyrrolidone (NMP), whereby positive electrode mix slurry was prepared. The positive electrode mix slurry was applied to both surfaces of a positive electrode core, made of aluminium, having a thickness of 15 μm by a doctor blade method. Thereafter, NMP was removed by drying, rolling was performed using a compression roller, and cutting to a predetermined size was then performed, whereby a positive electrode plate including the positive electrode core and positive electrode mix layers formed on both surfaces of the positive electrode core was prepared.

[Preparation of Negative Electrode Plate]

(Preparation of Silicon Oxide Negative Electrode Active Material)

A metallic silicon powder and a silicon dioxide powder were mixed together, followed by vacuum heat treatment, whereby a silicon oxide with a composition of SiO (corresponding to x=1 in SiOₓ) was obtained. Next, the silicon oxide was crushed and was then classified, followed by heating to about 1,000° C. The surfaces of particles thereof were coated with a carbon material by a CVD method in an argon atmosphere. In this operation, the coating amount of the carbon material was 5% by mass of the sum of the amount of the carbon material and the amount of the silicon oxide. This was pulverized and was then classified, whereby a negative electrode active material composed of the silicon oxide, surface-coated with the carbon material, having an average particle size of 5 μm was prepared.

The particle size of the silicon oxide represented by SiO was determined with a laser diffraction particle size distribution analyzer (SALD-2000A, manufactured by Shimadzu Corporation) using water as a dispersion medium in such a manner that the refractive index was set to 1.70-0.01 i. The average particle size was set to a particle size (D₅₀) corresponding to a cumulative particle percentage of 50% on a volume basis.

(Formation of Negative Electrode Mix Layers)

The silicon oxide, prepared as described above, represented by SiO and graphite with an average particle size of 21 μm were weighed, were mixed together so as to yield a blending ratio shown in Table 1, and were used as a negative electrode active material. Next, the negative electrode active material, a CMC-ammonium salt (Experiment Examples 1 to 4 and 6 to 10) or sodium salt (Experiment Example 5) serving as a thickener, and styrene-butadiene rubber (SBR) serving as a binding agent were mixed at a mass ratio of 97.0:1.5:1.5 in water, whereby negative electrode mix slurry was prepared. Negative electrode cores used had a thickness of 6 μm (Experiment Examples 1 to 5 and 7 to 10) or 8 μm (Experiment Example 6) and a surface roughness Rz of 1.4 μm (Experiment Examples 1 to 6), 1.7 μm (Experiment Example 7), 1.5 μm (Experiment Example 8), 0.8 μm (Experiment Example 9), or 0.7 μm (Experiment Example 10).

The surface roughness Rz represents a ten-point average roughness determined by a JIS method. The negative electrode mix slurry prepared as described above was applied to both surfaces of each negative electrode core made of copper foil by a doctor blade method. Next, after moisture was removed by drying, compression to a predetermined thickness was performed using a compaction roller, and cutting to a predetermined size was performed, whereby a negative electrode plate including the negative electrode core and negative electrode mix layers formed on both surfaces of the negative electrode core was prepared.

[Preparation of Nonaqueous Electrolyte Solution]

After ethylene carbonate (EC), methyl ethyl carbonate (MEC), and diethyl carbonate (DEC) were mixed at a volume ratio of 30:60:10 at 25° C., lithium hexafluorophosphate (LiPF₆) was dissolved such that the concentration thereof was 1 mol/L. Furthermore, 2.0% by mass of vinylene carbonate (VC) and 1.0% by mass of fluoroethylene carbonate (FEC) were added to an entire nonaqueous electrolyte solution and were dissolved therein, whereby the nonaqueous electrolyte solution was prepared.

[Preparation of Battery]

The positive electrode plate and negative electrode plate prepared as described above were wound with a separator therebetween, the separator being composed of a porous membrane made of polyethylene, and a polypropylene tape was attached to the outermost periphery, whereby a cylindrical wound electrode assembly was prepared. The cylindrical wound electrode assembly was pressed into a flat wound electrode assembly (not shown). Next, a positive electrode current-collecting tab and a negative electrode current-collecting tab were welded to the positive electrode plate and the negative electrode plate, respectively.

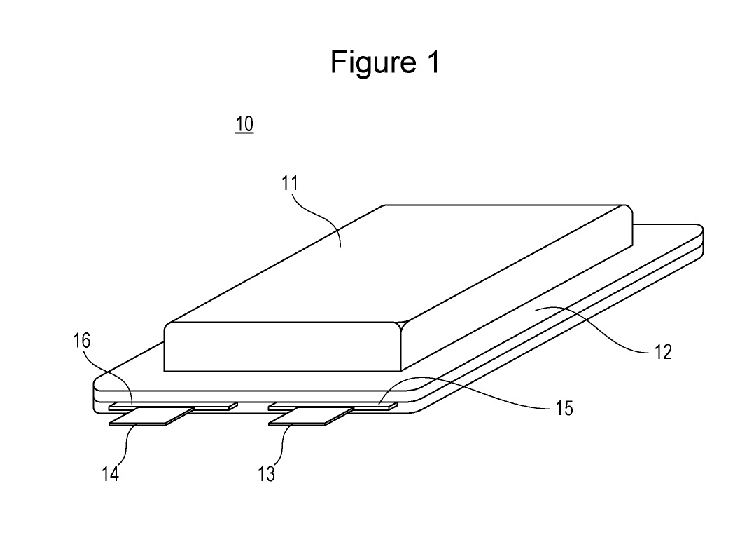

Herein, the configuration of the laminate-type nonaqueous electrolyte secondary battery common to the experiment examples is described using FIG. 1. The following member was prepared: a sheet-shaped aluminium laminate member having a five-layer structure consisting of a resin layer (polypropylene), an adhesive layer, an aluminium alloy layer, an adhesive layer, and a resin layer (polypropylene). A bottom portion was formed by folding the aluminium laminate material, whereby a laminate enclosure 11 having a cup-shaped electrode assembly-storing space was prepared. Next, in a glove box under an argon atmosphere, the flat wound electrode assembly and the nonaqueous electrolyte solution were provided in the cup-shaped electrode assembly-storing space and the positive electrode current-collecting tab 13 and the negative electrode current-collecting tab 14 connected to the positive electrode plate and the negative electrode plate, respectively, of the flat wound electrode assembly were extended from a welding sealed portion 12 of the laminate enclosure 11.

Thereafter, the separator was impregnated with the nonaqueous electrolyte solution by evacuating the laminate enclosure 11 and an opening of the laminate enclosure 11 was then sealed at the welding sealed portion 12. In the laminate enclosure 11, a positive electrode current-collecting tab resin 15 was placed between the positive electrode current-collecting tab 13 and the laminate enclosure 11 and a negative electrode current-collecting tab resin 16 was placed between the negative electrode current-collecting tab 14 and the laminate enclosure 11 for the purpose of increasing the adhesion between the positive electrode current-collecting tab 13 and the laminate enclosure 11 and the adhesion between the negative electrode current-collecting tab 14 and the laminate enclosure 11 and for the purpose of preventing short-circuiting between the positive electrode current-collecting tab 13 and the aluminium alloy layer, which constitutes the laminate enclosure 11, and short-circuiting between the negative electrode current-collecting tab 14 and the aluminium alloy layer. The obtained laminate-type nonaqueous electrolyte secondary battery 10 common to the experiment examples had a height of 62 mm, a width of 35 mm, and a thickness of 3.6 mm. (excluding the size of the welding sealed portion 12) and also had a design capacity of 800 mAh at a charge cut-off voltage of 4.4 V.

Different components of nonaqueous electrolyte secondary batteries of the experiment examples are described below.

### EXPERIMENT EXAMPLES 1 to 4

In nonaqueous electrolyte secondary batteries of Experiment Examples 1 to 4, the following plates were used: negative electrode plates prepared by varying the content of the silicon oxide represented by SiO in the negative electrode active material to 0-3% by mass (Experiment Example 1), 0.5% by mass (Experiment Example 2), 20.0% by mass (Experiment Example 3), and 22.0% by mass (Experiment Example 4). On this occasion, in each example, an ammonium salt of CMC was used and copper foil having a thickness of 6 μm and a surface roughness Rz of 1.4 μm was used as a negative electrode core.

### EXPERIMENT EXAMPLES 5 AND 6

In a nonaqueous electrolyte secondary battery of Experiment Example 5, the following plate was used: a negative electrode plate that was prepared in such a manner that copper foil having a thickness of 6 μm and a surface roughness Rz of 1.4 μm was used as a negative electrode core, the content of the silicon oxide represented by SiO in the negative electrode active material was 1.0% by mass, and a sodium salt of CMC was used. In a nonaqueous electrolyte secondary battery of Experiment Example 6, the following plate was used: a negative electrode plate that was prepared in such a manner that copper foil having a thickness of 8 μm and a surface roughness Rz of 1.4 μm was used as a negative electrode core, the content of the silicon oxide represented by SiO in the negative electrode active material was 1.0% by mass, and an ammonium salt of CMC was used.

### EXPERIMENT EXAMPLES 7 TO 10

Nonaqueous electrolyte secondary batteries of Experiment Examples 7 to 10 were prepared using copper foils with a thickness of 6 μm (Experiment Examples 7 to 10) as negative electrode cores such that the content of the silicon oxide represented by SiO in the negative electrode active material was 1.0% by mass. The copper foils had a surface roughness Rz of 1.7 μm (Experiment Example 7), 1.5 μm (Experiment Example 8), 0.8 μm (Experiment Example 9), or 0.7 μm (Experiment Example 10). On this occasion, all in each example, an ammonium salt of CMC was used.

[Measurement of Adhesion of Negative Electrode Plate]

For the peel strength of each negative electrode plate, after the negative electrode mix slurry was applied to both surfaces of a negative electrode core made of copper foil by a doctor blade method and moisture was removed by drying, compression to a predetermined thickness was performed using a compaction roller. Thereafter, an adhesive tape was attached to a surface of a negative electrode mix layer and was then peeled off by applying a predetermined force to the adhesive tape. The strength was measured when the negative electrode mix layer was peeled off.

[Measurement of Compressibility]

For negative electrode plates of Experiment Examples 1 to 10, after the negative electrode mix slurry was applied to both surfaces of each negative electrode core made of copper foil by a doctor blade method and moisture was removed by drying, the negative electrode plates were compressed to a predetermined thickness using a compaction roller and were then visually observed for surface condition. Ten pieces of each of Experiment Examples 1 to 10 were measured. The case where none of negative electrode cores was broken was rated “A”. The case where one or more of negative electrode cores were broken was rated “B”.

[Measurement of 300th-Cycle Capacity Retention]

After the nonaqueous electrolyte secondary battery of each of Experiment Examples 1 to 10 was charged at a constant current of 1 lt=800 mA at 25° C. until the voltage of the battery reached 4.4 V, the battery was charged at a constant voltage of 4.4 V until the current converged to 40 mA. Next, the battery was charged at a constant current of 1 lt=800 mA at until the battery voltage reached 2.5 V. The current flowing in this operation was determined as the first-cycle discharge capacity. This charge/discharge cycle was repeated, followed by determining the 300th-cycle discharge capacity. The 300th-cycle capacity retention was determined by a calculation formula below.

300th-cycle capacity retention (%)=(300th-cycle discharge capacity/first-cycle discharge capacity)×100

Measurement results of Experiment Examples 1 to 10 are summarized in Table 1 together with the content of the silicon oxide represented by SiO in a negative electrode active material, the type of a CMC salt, properties of copper foil serving as a negative electrode core, and the first-cycle discharge capacity.

TABLE 1

| | | | | Surface | Adhesion of | | First-cycle | 300th-cycle |
|---|---|---|---|---|---|---|---|---|
| | | | Thickness | roughness | electrode | | discharge | capacity |
| | Content of SiO | | of core | Rz | plate | Compressibility | capacity | retention |
| | (mass percent) | CMC type | (μm) | (μm) | (mN/cm²) | (visual) | (mAh) | (%) |
| Experiment | 0.3 | Ammonium salt | 6 | 1.4 | 168 | A | 753 | 85.7 |
| Example 1 | | | | | | | | |
| Experiment | 0.5 | Ammonium salt | 6 | 1.4 | 181 | A | 819 | 86.5 |
| Example 2 | | | | | | | | |
| Experiment | 20.0 | Ammonium salt | 6 | 1.4 | 176 | A | 844 | 84.9 |
| Example 3 | | | | | | | | |
| Experiment | 22.0 | Ammonium salt | 6 | 1.4 | 165 | A | 858 | 65.2 |
| Example 4 | | | | | | | | |
| Experiment | 1.0 | Sodium salt | 6 | 1.4 | 107 | A | 809 | 61.3 |
| Example 5 | | | | | | | | |
| Experiment | 1.0 | Ammonium salt | 6 | 1.4 | 174 | A | 812 | 85.8 |
| Example 6 | | | | | | | | |
| Experiment | 1.0 | Ammonium salt | 6 | 1.7 | 168 | B (broken) | — | — |
| Example 7 | | | | | | | | |
| Experiment | 1.0 | Ammonium salt | 6 | 1.5 | 177 | A | — | — |
| Example 8 | | | | | | | | |
| Experiment | 1.0 | Ammonium salt | 6 | 0.8 | 174 | A | 816 | 85.9 |
| Example 9 | | | | | | | | |
| Experiment | 1.0 | Ammonium salt | 6 | 0.7 | 123 | A | — | — |
| Example 10 | | | | | | | | |

The following is clear from measurement results of Experiment Examples 1 to 4 shown in Table 1. That is, in the case where the CMC-ammonium salt is used as a thickener and copper foil having a thickness of 6 μm and a surface roughness of 1.4 μm as a negative electrode core, when the content of the silicon oxide in the negative electrode active material is 0.5% to 20% by mass, good results are obtained for the adhesion of an electrode plate, compressibility, the first-cycle discharge capacity, and the 300th-cycle capacity retention.

However, in Experiment Example 1, in which the content of the silicon oxide in the negative electrode active material is low, 0.3% by mass, although the compressibility and the 300th-cycle capacity retention are good, the adhesion of the electrode plate and the first-cycle discharge capacity are inferior to those obtained in Experiment Examples 2 and 3. Furthermore, in Experiment Example 4, in which the content of the silicon oxide in the negative electrode active material is high, 22% by mass, although the compressibility and the first-cycle discharge capacity are good, the adhesion of the electrode plate and the 300th-cycle capacity retention are inferior to those obtained in Experiment Examples 2 and 3.

Such measurement results of Experiment Example 1 are probably due to the fact that the effect of increasing the capacity of the silicon oxide is not achieved because the content of the silicon oxide in the negative electrode active material is low and the capacity retention is good because the expansion and contraction due to charge and discharge are slight. Measurement results of Experiment Example 4 are probably due to the fact that although the first-cycle discharge capacity is large because the content of the silicon oxide in the negative electrode active material is high, which is contrary to the case of Experiment Example 1, the adhesion of the electrode plate and the 300th-cycle capacity retention are low because the expansion and contraction due to charge and discharge are significant.

The followings are clear from comparisons between measurement results of Experiment Example 5 and those of Experiment Examples 2 and 3. That is, the adhesion of the electrode plate and the 300th-cycle capacity retention of Experiment Example 5 are significantly lower than those of Experiment Examples 2 and 3. Since the content of the silicon oxide in the negative electrode active material of Experiment Example 5 is intermediate between those of Experiment Examples 2 and 3, both the adhesion of the electrode plate and the 300th-cycle capacity retention should be substantially equal to those of Experiment Examples 2 and 3. Then, the difference in configuration between Experiment Example b and Experiment Examples 2 and 3 is substantially only whether the ammonium salt of CMC (Experiment Examples 2 and 3) or the sodium salt of CMC (Experiment Example 5) was used. Hence, it is clear that as a thickener, the CMC-ammonium salt provides a more excellent effect as compared to the CMC-sodium salt.

According to measurement results of Experiment Example 6 and Experiment Examples 2 and 3, both provide substantially the same excellent effects. The difference in configuration between Experiment Example 6 and Experiment Examples 2 and 3 is substantially only whether the thickness of copper foil used as a negative electrode core is 8 μm (Experiment Example 6) or 6 μm (Experiment Examples 2 and 3). Therefore, in the case of using the CMC-ammonium salt as a thickener, it is clear that when the thickness of a negative electrode core ranges at least from 6 μm to 8 μm, the negative electrode core can be used well.

The followings are clear from comparisons between measurement results of Experiment Examples 7 to 10. That is, the negative electrode plate of Experiment Example 7 was broken when rolling to a predetermined thickness was performed using the compaction roller after the negative electrode mix slurry was applied to both surfaces of the negative electrode core made of copper foil by the doctor blade method and moisture was removed by drying. However, the negative electrode plates of Experiment Examples 8 to 10 were not broken when rolling to a predetermined thickness was performed using the compaction roller after the negative electrode mix slurry was applied to both surfaces of each negative electrode core made of copper foil by the doctor blade method and moisture was removed by drying.

However, the difference in configuration between Experiment Examples 7 to 10 is only the surface roughness Rz of copper foil as a negative electrode core. Therefore, in the case of using the CMC-ammonium salt as a thickener, it is clear that the surface roughness Rz of copper foil as a negative electrode core is preferably 0.8 μm to 1.5 μm. In this case, in consideration of the extrapolation of results of Experiment Examples 2, 3, 6, 8, and 9, it is conceivable that copper foil can be sufficiently used as a negative electrode core when the thickness of the copper foil ranges from 5.9 μm to 8.1 μm.

In each experiment example, the silicon oxide with a composition of SiO (corresponding to x=1 in SiOₓ) was used. When x is within the range 0.5≦x<1.6, a good effect is similarly achieved. When x is less than 0.5, an Si component is rich and therefore the expansion and contraction due to charge and discharge are significant; hence, the capacity retention is low. When x is more than 1.6, an SiO₂ component is rich and therefore the effect of increasing the capacity of a negative electrode is low.

In each experiment example, the silicon oxide, represented by SiO, having an average particle size of 5 μm was used. When the average particle size of the silicon oxide is 4 μm to 12 μm, a good effect is similarly achieved. Graphite with an average particle size of 21 μm was used. When the average particle size of graphite ranges from 16 μm to 24 μm, a good effect is similarly achieved.

An example in which the additive amount of CMC in a negative electrode mix and the additive amount of SBR therein are both 1.5% by mass of the entire negative electrode mix has been described. When the additive amount of CMC and the additive amount of SBR content each range from 0.5% to 2% by mass, a good effect is similarly achieved. Likewise, an example in which the additive amount of VC in a nonaqueous electrolyte solution is 2.0% by mass and the additive amount of FEC therein is 1.0% by mass has been described. When the additive amount of VC ranges from 1% to 5% by mass and the additive amount of FEC ranges from 0.5% to 5% by mass, a good effect is similarly achieved. Furthermore, an example in which the coating amount of a carbon material covering the surface of the silicon oxide represented by SiO is 5% by mass of the sum of the amount of the carbon material and the amount of the silicon oxide has been described. When the coating amount ranges from 1 to 10 mass, a good effect is similarly achieved.

In each experiment example, an example in which the zirconium-magnesium-aluminium-containing lithium-cobalt composite oxide with a composition of LiCo_{0.979}Zr_{0.001}Mg_{0.01}Al_{0.01}O₂ is used as a positive electrode active material has been described. However, in the present invention, not only compositions containing different amounts of different metal elements such as zirconium, magnesium, and aluminium but also known compounds capable of storing and releasing lithium ions can be used. Examples of the compounds capable of storing and releasing lithium ions include lithium-transition metal composite oxides (that is, LiCoO₂, LiNiO₂, LiNi_{y}Co_{1-y}O₂ (y is 0.01 to 0.99), LiMnO₂, LiCoₓMn_{y}Ni_{z}O₂ (x+y+z=1), and the like) represented by LiMO₂ (where M is at least one of Co, Ni, and Mn), LiMn₂O₄, LiFePO₄, and the like. These compounds can be used alone or in combination.

The following compounds can be used as a nonaqueous solvent in a nonaqueous electrolyte solution that can be used in a nonaqueous electrolyte secondary battery according to the present invention: for example, cyclic carbonates such as ethylene carbonate (EC), propylene carbonate (PC), and butylene carbonate (BC); fluorinated cyclic carbonates; cyclic carboxylates such as γ-butyrolactone (γ-BL) and γ-valerolactone (γ-VL); linear carbonates such as dimethyl carbonate (DMC), ethyl methyl carbonate (FMC), diethyl carbonate (DEC), methyl propyl carbonate (MPC), and dibutyl carbonate (DBC); fluorinated linear carbonates; linear carboxylates such as methyl pivalate, ethyl pivalate, methyl isobutyrate, and methyl propionate; amide compounds such as N,N′-dimethylformamide and N-methyloxazolidinone; sulfur compounds such as sulfolane; room-temperature molten salts such as 1-ethyl-3-methylimidazolium tetrafluoroborate; and the like. These compounds can be used in combination.

A lithium salt generally used in nonaqueous electrolyte secondary batteries as an electrolyte salt can be used as an electrolyte salt dissolved in a nonaqueous solvent in a nonaqueous electrolyte solution that can be used in a nonaqueous electrolyte secondary battery according to the present invention. Examples of the lithium salt include lithium hexafluorophosphate (LiPF₆), LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂) ₃, LiAsF₆, LiClO₄, Li₂B₁₀Cl₁₀, and Li₂B₁₂Cl₁₂, and the like. These slats can be used alone or in combination. Among these salts, LiPF₆ is particularly preferable. The amount of the electrolyte salt dissolved in the nonaqueous solvent is preferably 0.8 mol/L to 1.5 mol/L.

The following compounds may be added to a nonaqueous electrolyte solution in a nonaqueous electrolyte secondary battery according to the present invention as compounds for stabilizing electrodes: for example, vinylene carbonate (VC), vinylethylene carbonate (VEC), succinic anhydride (SUCAH), maleic anhydride (MAAH), glycolic anhydride, ethylene sulfite (ES), divinyl sulfone (VS), vinyl acetate (VA), vinyl pivalate (VP), catechol carbonate, biphenyl (BP), and the like. These compounds may be used in combination.

### REFERENCE SIGNS LIST

10 Laminate-type nonaqueous electrolyte secondary battery

11 Laminate enclosure

12 Welding sealed portion

13 Positive electrode current-collecting tab

14 Negative electrode current-collecting tab

15 Positive electrode current-collecting tab resin

16 Negative electrode current-collecting tab resin

1. A negative electrode plate for nonaqueous electrolyte secondary batteries, comprising
a negative electrode mix layer, placed on a negative electrode core, containing a negative electrode active material capable of storing and releasing lithium ions,
wherein the negative electrode core is copper foil having a thickness of 5.9 μm to 8.1 μm and a surface roughness Rz of 0.8 μm to 1.5 μm,
the negative electrode mix layer contains the negative electrode active material, a binding agent, and a carboxymethylcellulose-ammonium salt, the negative electrode active material being composed of a mixture of a graphite material and a silicon oxide represented by SiOₓ (0.5≦x<1.6), and
the content of the silicon oxide in the negative electrode active material is 0.5% to 20% by mass.

2. The negative electrode plate for nonaqueous electrolyte secondary batteries according to claim 1, wherein the negative electrode mix layer contains styrene-butadiene rubber as a binding agent.

3. The negative electrode plate for nonaqueous electrolyte secondary batteries according to claim 1, wherein the surface of the silicon oxide is coated with a carbon material.

4. A nonaqueous electrolyte secondary battery comprising:
the negative electrode plate according to claim 1;
a positive electrode plate including a positive electrode mix layer containing a positive electrode active material capable of storing and releasing lithium ions;
a separator; and
a nonaqueous electrolyte.

5. The nonaqueous electrolyte secondary battery according to claim 4, comprising a flat wound electrode assembly in which the negative electrode plate and the positive electrode plate are flatly wound in such a state that the negative electrode plate and the positive electrode plate are insulated from each other with the separator therebetween.

6. The negative electrode plate for nonaqueous electrolyte secondary batteries according to claim 2,
wherein the surface of the silicon oxide is coated with a carbon material.

7. A nonaqueous electrolyte secondary battery comprising:
the negative electrode plate according to claim 2;
a positive electrode plate including a positive electrode mix layer containing a positive electrode active material capable of storing and releasing lithium ions;
a separator; and
a nonaqueous electrolyte.

8. A nonaqueous electrolyte secondary battery comprising:
the negative electrode plate according to claim 3;
a positive electrode plate including a positive electrode mix layer containing a positive electrode active material capable of storing and releasing lithium ions;
a separator; and
a nonaqueous electrolyte.

9. A nonaqueous electrolyte secondary battery comprising:
the negative electrode plate according to claim 6;
a positive electrode plate including a positive electrode mix layer containing a positive electrode active material capable of storing and releasing lithium ions;
a separator; and
a nonaqueous electrolyte.

10. The nonaqueous electrolyte secondary battery according to claim 7, comprising a flat wound electrode assembly in which the negative electrode plate and the positive electrode plate are flatly wound in such a state that the negative electrode plate and the positive electrode plate are insulated from each other with the separator therebetween.

11. The nonaqueous electrolyte secondary battery according to claim 8, comprising a flat wound electrode assembly in which the negative electrode plate and the positive electrode plate are flatly wound in such a state that the negative electrode plate and the positive electrode plate are insulated from each other with the separator therebetween.

12. The nonaqueous electrolyte secondary battery according to claim 9, comprising a flat wound electrode assembly in which the negative electrode plate and the positive electrode plate are flatly wound in such a state that the negative electrode plate and the positive electrode plate are insulated from each other with the separator therebetween.
